(19) United States
(12) Patent Application Publication
(10) Pub. No.: US 2007/0274568 A1
(43) Pub. Date: Nov. 29, 2007

(54) Automatic Performance Calibration (APC)

(76) Inventor: Julian Mark Douglas Ashbourn, Berkhamsted (GB)

Correspondence Address: JOEL D. SKINNER, JR.;SKINNER AND ASSOCIATES, 212 COMMERCIAL ST., HUDSON, WI, 54016, US

(21) Appl. No.: 10/587,473

(22) PCT Filed: Feb. 3, 2005
(86) PCT No.: PCT/GB05/00377

§ 371 Date: Jun. 11, 2007

(30) Foreign Application Priority Data
Feb. 4, 2004 (GB) 0402421.2

(51) Int. Cl. G06K 9/00

(52) U.S. Cl. 382/115

(57) ABSTRACT

An Automatic Performance Calibration (APC) technique comprises monitoring transactional performance of a bio-metric device and re-calibrating the device automatically as required in order to achieve a pre-determined performance level.

This invention relates to a technique to allow the performance of one or more biometric devices or other readers to be calibrated automatically.

As the principle of biometric personal identity verification becomes widespread, as in public applications for example, the issue of interoperability and equivalence of performance adopts increasing importance. This is particularly the case where applications are operated over multiple sites. In such an instance, a given individual may pass a biometric check at one location and fail at another, even using the same reference template and similar hardware. If the biometric equipment at a particular point of presence is calibrated differently to equipment at another, or interacts differently within its local environment, it is likely that actual performance will also vary, creating a high probability of the scenario mentioned above. The situation is further complicated by variables of environment and user psychology, making equivalence of both performance and user experience problematic. This can lead to further complications of process and exception handling, especially in high profile applications such as border crossing, social service provision and the like. Such a situation would quickly become troublesome and may lead local operators to compromise the process and thereby somewhat defeating the original object.

If we start with the assumption that what we are seeking is a higher level of confidence as to the true identity of a given individual, either via an automated or attended process, then we can, according to the perceived level of risk, specify a typical performance requirement accordingly. This operational performance should ideally be realised at each point of presence, whether on the same site or across multiple sites. We could seek to achieve this manually by careful monitoring and fine adjustment of the matching threshold at each sensor. However, this would be very labour intensive and would in any case not be consistent due to possible variations over time. It would be far better if such a process could be automated, whereby a desired performance level is set and the equipment is self calibrating in order to maintain the chosen level of performance over time and across multiple points of presence. This is the purpose of the APC function, and the subject of this application.

According to the invention there is provided an Automatic Performance Calibration (APC) system to continually monitor transactional performance and re-calibrate a biometric device automatically as required in order to achieve a pre-determined performance level. It is important to note the distinction between performance calibration and absolute calibration. The former seeks to achieve a given actual performance (in terms of acceptable error rates) while the latter is simply calibration to a known reference. For real world operational systems and processes, it is actual performance that is the important criterion.

The APC system conveniently uses a method comprising the steps of:

(a) generating a score each time a match is made between data input using a reader and representative of a biometric characteristic and stored data;

(b) calculating an average value of the scores for a plurality of matches;

(c) comparing the calculated average value with a predetermined performance threshold; and

(d) adjusting the calibration of the reader in response to the result of the comparison in step (c).

The APC system will adjust device performance dynamically according to a pre-determined reference. The organisation implementing the biometric application may thus specify a target level of performance and the biometric devices deployed will be automatically and continually calibrated in order to achieve this level of performance (providing of course it is within the bounds of the device in question). The implementing organisation may thus feel confident that an equivalent level of performance is being realised across multiple points of presence, an important consideration for many applications, especially wide scale applications within the public sector. The APC system may be implemented as software which may be easily integrated with operational software and hardware for the purpose of biometric identity verification checks.

The invention will further be described, by way of example, with reference to the accompanying drawings (FIGS. 1 to 4) which are graphs representative of the scores from four sets of matches.

Operation of the APC is as follows. A biometric reader device and associated control software is used to allow the input of biometric data and to match the input data with data stored in a memory. The biometric device will, upon each attempted transaction, output a ‘score’ to indicate how closely the live biometric sample matches with the stored reference. Within the range of possible scores will be a threshold level, below which a match will be regarded as negative, above which a match will be regarded as positive. This threshold setting is often manually programmable and will determine the relative performance of the device in question, in terms of realised error rates. The APC will continually adjust this threshold in real time order to realise the desired performance level.

The operational steps are as follows;

1] Upon a match transaction, the biometric device outputs a score.

2] The APC numbers each transaction and writes the score to a database.

3] Upon reaching a set number of transactions (programmable) the APC sums the scores and divides the total by the number of transactions in order to arrive at an average score.

4] The APC compares this average score with the pre-programmed aspirational performance.

5] If the score is not aligned with the required performance according to a given tolerance, the threshold setting of the biometric device will be altered in order to realise a closer alignment.

6] The process will be repeated after every batch of transactions, ensuring that actual performance is evenly maintained.

The use of APC with a given biometric device, such as may be found within a self service kiosk for example, will ensure that a given level of performance is maintained, regardless of initial device calibration, environmental and operational variables, or other conditions which may affect realised performance. Furthermore, this benefit is increased pro rata as the number of deployed devices increases, an important consideration for major applications. The use of APC enables the implementing organisation to concentrate its resources on exceptions which fall outside of the desired operational performance envelope, knowing that they are doing so on a consistent basis and not simply reacting to the consequence of poorly calibrated devices. The following example describes the operation of APC in greater detail.

For this example we are assuming the use of fingerprint readers in our application and have specified our desired performance as an acceptable false reject rate of between 1.0% and 1.5% and an acceptable false accept rate of 1% or less. The APC code built into the application software will enable us to select these parameters. It will also enable us to select a sampling frequency at which to run the APC agent which, in turn, interacts directly with the biometric device in order to dynamically adjust the matching threshold. For our example we have specified this as every 25 transactions. Having set these parameters, we are now ready to operate the system in a live environment and allow the APC function to maintain an acceptable level of performance on our behalf. This following results show the operation in practice.

1] The first 25 transactions are monitored with the resultant scores entered into the APC database. Note, that this database simply stores transaction number and score. It has no possibility to store user related data and cannot associate a transaction with a user. This is not the purpose of APC. The initial set of transactions are reproduced in FIG. 1.

An average score value for these transactions is calculated by adding the individual scores together and dividing the total by the number of transactions involved. For the first set of 25 transactions the average score is 20.92, which reflects a false reject rate (FRR) of 2.08 and the probability of a false accept rate (FAR) of 0.35. While the FAR is acceptable according to our specified requirements, the FRR is not. The APC software understands this from the band of acceptable average scores necessary to achieve our requirements. It therefore adjusts the matching threshold of the biometric device ready for the next 25 transactions.

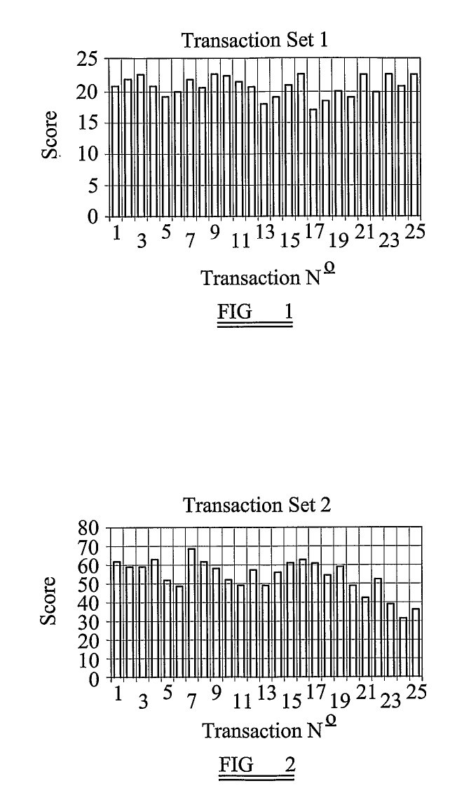

2] The second, subsequent set of transactions return the scores shown in FIG. 2.

This second set of transactions, which have been undertaken under the revised threshold setting, return an average score of 53.76, which reflects an FRR of 1.42% and the probability of an FAR of 0.90%. These figures fall comfortably within our specified performance requirements, following the interaction of the APC function. However, for a variety of reasons, this realised performance may vary over time and so the APC software continues to monitor transactions accordingly.

3] Ongoing transaction monitoring results in the set of scores shown in FIG. 3.

With the third set of data, we find that the average score has changed to 78.52, reflecting an FRR of 0.93% and the probability of an FAR of 1.31%. While the FRR figure looks encouraging, this is achieved at the expense of a likely FAR well outside of our specifications. The APC software re-adjusts the matching threshold accordingly and continues to monitor the resultant transactions.

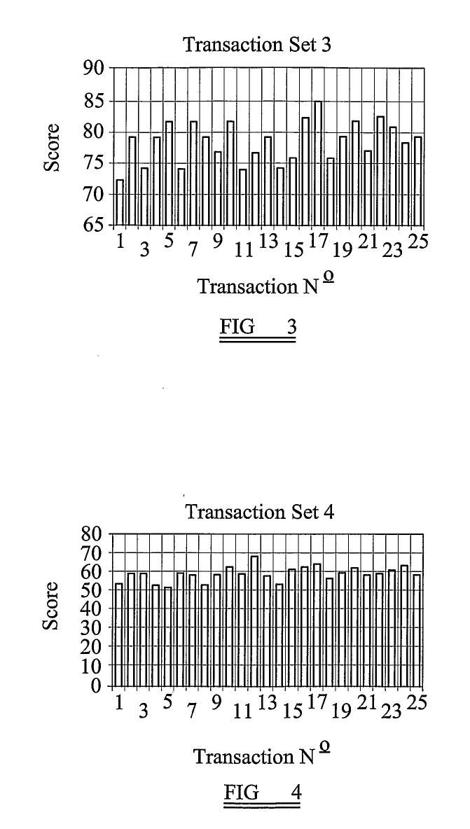

4] The next set of transactions results in the data illustrated in FIG. 4.

With the fourth set of transactions, we can see that the average score has been brought back to 58.64, reflecting an FRR of 1.33% and a likely FAR of 0.98%. These figures are within our specified requirements, the APC software working well to deliver the realised performance anticipated for the application in question.

By setting the frequency at which APC operates, we can control the realised performance with a fine or coarse granularity, according to the requirements of the application in question. This allows us to keep actual performance consistent across both time and points of presence, thus providing equivalence between devices and a consistent level of overall performance. All the implementing organisation has to do is decide upon an acceptable level of performance according to the precise nature of the application, and then set the APC module, embedded into the host software, accordingly. The APC function will then operate in the background to provide the desired level of performance. For multiple points of presence, or even multiple sites, these parameters may be set centrally and downloaded to the devices in question. If desired, a change in threshold value may be implemented centrally and effect all or a selection of the reader devices of the system. The invention may be used with systems including a plurality of reader devices all of the same type (for example design of reader) or systems having two or more types of reader device, and so may be used in a wide range of applications including applications in which different characteristics are read in different locations.

APC represents an innovative breakthrough with regard to the realised and sustainable performance of biometric identity verification devices. As such, it will play an important part in large scale public applications which utilise biometric technology and seek to provide consistent performance and equivalence of operation across multiple points of presence, whether they be on the same site or geographically separated. When developing applications, users and systems integrators may thus specify a performance objective (using the Biometric Operability index) with confidence that this may be achieved consistently under real operational conditions (subject to the ability of the devices deployed). This capability represents a very significant step forwards with regard to the wide-scale deployment of biometrics.

It will be appreciated that the invention described hereinbefore may be applied to any identification system having a plurality of readers in which the readers can be configured to allow different input acceptance and rejection levels, and is not restricted to fingerprint readers as described herein.

1. An Automatic Performance Calibration (APC) technique comprising monitoring transactional performance of a device and re-calibrating the device automatically as required in order to achieve a pre-determined performance level.

2. A technique according to claim 1, wherein the technique uses a method comprising the steps of (a) generating a score each time a match is made between data input using a reader and representative of a biometric characteristic and stored data; (b) calculating an average value of the scores for a plurality of matches; (c) comparing the calculated average value with a predetermined performance threshold; and (d) adjusting the calibration of the reader in response to the result of the comparison in step (c).

3. A technique according to claim 2, wherein the average score is calculated for a batch of a predetermined number of matches.

4. A technique according to claim 1, wherein a plurality of devices are provided.

5. A technique according to claim 4, wherein a change in threshold value is implemented centrally and effects all or a selection of the reader devices.

6. A technique according to claim 4, wherein the devices are all of the same type.

7. A technique according to claim 4, wherein the devices are of a plurality of different types.

8. (canceled)

9. (canceled)
